(19) United States
(12) Patent Application Publication
(10) Pub. No.: US 2002/0046135 A1
(43) Pub. Date: Apr. 18, 2002

(54) Marketing arrangement for goods and services

(76) Inventor: Mark C. Lage, Bergenfield, NJ (US)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 09/977,802

(22) Filed: Oct. 15, 2001

Related U.S. Application Data
(60) Provisional application No. 60/240,893, filed on Oct. 17, 2000.

(51) Int. Cl. G06F 17/60

(52) U.S. Cl. 705/26

(57) ABSTRACT

An improved arrangement for the marketing of goods and services between marketers and consumers. Each participating consumer has an account to which value is accumulated upon the consumer carrying out any of number of predetermined events. Each event has an associated value and one or more associated marketers. The events include the purchase of goods and/or services as well as other activities. These other activities are virtually limitless and may, e.g., entering a particular store, viewing a certain communication, clicking on an Internet banner, etc. In any event, the value accumulated in the account is a function of the value of the event and a “pay out” factor alterable in real-time by the associated marketer. The value accumulated in the consumer's account is redeemable toward the acquisition of goods, services and cash. Each acquisition is associated with a decrease in the account value. The decrease is a function of the value of the item redeemed and “buy back” factor which is also alterable in real-time. The pay out and buy back factors may be independent of one another. With the notion of pay out and buy back factors, the value accumulated and redeemed can be viewed as currency—not legal tender issued by a sovereign power—but one that is acceptable with a virtually boundless group of consumers and marketers for a equally boundless number of different goods and services.

### TECHNICAL FIELD

The present invention relates to a marketing arrangement for goods and/or services and, more particularly, to one that is universal and which satisfies the needs of both consumers and marketers.

### BACKGROUND OF THE INVENTION

There are a plethora of marketing schemes for promoting the relationship between consumers and marketers. For purposes of this application, the term “marketer” shall be used to denote a provider of any type of goods and/or services. The notion of a provider includes any wholesaler, retailer, distributor, and/or manufacturer, i.e., any business in the stream of commerce up to the point of sale.

Marketers desire to both develop relationships with large numbers of consumers and, most importantly, maintain those relationships. That is, acquiring a customer without some mechanism for developing and maintaining that customer's loyalty is, at best, of short-term value.

Credit cards and debit cards are ubiquitous and are common marketing tools for promoting the relationship between consumers and marketers. The use of credit or debit cards to purchase goods and/or services, in lieu of using cash at the time of sale, is very attractive to most consumers. Indeed, the desirability of credit and debit cards is to such a degree that many consumers accumulate a large number of such cards. The problem, however, is that consumers acquire and change their cards on a frequent basis. During the limited time that a particular card is possessed, it may only be used sporadically.

Affinity cards are a type of credit or debit card that has been developed with the aim of promoting customer loyalty to marketers, stimulating card usage and extending the period of use. Affinity cards are issued by banking institutions with some affiliation to a group of providers. Typically, these providers are in a common generic business. One such generic business is the travel business where, for example, a limited number of airlines, hotels and rental cars have formed an affiliation. With an affinity card, the use of the card by a cardholder results in some “value” being created for that cardholder. Typically, the value is in the form of loyalty “points”, or the like, that accrue upon the purchase of goods and/or services from any of the marketers in the affiliation. The value accrued for any purchase tracks the money spent for the purchased goods and/or services.

Stimulation of sales with affinity cards has been accomplished through the use of promotional offerings in which points earned for certain goods and/or services are multiplied by some factor. One example, is “double mileage points” for tickets purchased for travel on certain routes during a predetermined time period. Or, another example is increased points earned if first class tickets are purchased in lieu of coach class tickets. The factor used by a marketer is communicated to consumers through mass mailings or by notice on the marketer's web site. The time interval during which the factor is applicable is typically for months or weeks. After a cardholder accrues, value in his/her account, the cardholder may redeem such value to obtain the goods and/or services provided by the marketers in the affiliation.

The present arrangements which use credit or debit cards to promote and maintain the relationship between marketers and consumers provide advantages, but have a number of shortcomings. These shortcomings are present from a number of viewpoints. From the perspective of the card-issuer, which may be a bank or a bank-provider affiliation, there is a significant cost of acquiring cardholders. In 1999, it has been estimated that such cost is in the range of $30-$90 for each consumer who elects to sign up for a particular credit or debit card. Once a cardholder signs up for a card, there is the constant need to stimulate that cardholder to use the card. Indeed, billions of dollars are spent in the U.S. alone to stimulate card usage through mass media advertisements and the like. There is also the issue of cardholder “churn”. That is, cardholders after a short period after sign-up, cease using a particular card and sign-up for different one.

There are several reasons for cardholder churn. One reason is that cardholders view a credit card or debit card as a commodity item. The use of affinity card programs may provide some incentive to retain a card, but this incentive is oftentimes quickly dissipated. One reason for this dissipation is that the holder of an affinity card recognizes that the accrued value in his/her account is only redeemable toward the purchase of a limited class of goods and/or services. While the cardholder initially wants to procure goods and/or services with redeemable points, after doing so, the desire for future redemption is diminished. Another reason is that consumers with multiple credit and/or debit cards generally accumulate value in multiple accounts. The value accumulated in any one account may then be insufficient for the redemption of any goods and/or services desired by the cardholder. In time, the cardholder becomes disenchanted with the process of accruing value and this cardholder's loyalty wanes.

Based on the foregoing, it would be extremely desirable if a marketing technique could be developed that provides substantial benefits to both consumers and marketers. Such a technique should develop consumer loyalty, maintain that loyalty, and promote the sale of a limitless number of different goods and/or services.

### BRIEF DESCRIPTION OF THE DRAWING

FIG. 1 is a block-schematic diagram of an exemplary system that implements the proposed marketing arrangement;

FIG. 2 is a block schematic diagram of various devices which may be located at a point-of-sale of goods and/or services in the system of FIG. 1; and

FIG. 3 is an illustrative representation of one video screen viewable by a consumer who participates in the system of FIG. 1.;

FIG. 4 is an illustrative representation of another video screen viewable by a consumer who participates in the system of FIG. 1;

FIG. 5 is an illustrative representation of a video screen that has been customized for a particular consumer who participates in the system of FIG. 1;

FIG. 6 is a flow chart of the operations associated with the, accrual of value in the account of a consumer participating in the system of FIG. 1; and

FIG. 7 is a flow chart of the flow chart of the operations associated with the redemption of value from the account of a consumer who participates in the system of FIG. 1.

### DETAILED DESCRIPTION

The proposed marketing arrangement is applicable as a standalone concept or as one that can be added to any existing credit card or debit card system. Pursuant to the present arrangement, consumers and marketers are given the opportunity to join a group. Once any marketer or consumer joins the group, it will hereinafter be respectively referred to as a participating marketer and a participating consumer. Participating marketers are providers of goods and/or services. They may be retailers, wholesalers, distributors or manufacturers. A participating consumer, upon electing to participate in the group, is given something to indicate his/her participation. The identification can be imbedded in a virtually limitless number of devices. Such devices may take the form of a credit card, “smart” card, or key chain tag. The identification may also be embedded into a wireless pager, cellular telephone or other electronic transmitters. The embedding of the identification into a device otherwise carried by the participating consumer avoids the need for that individual to carry an additional item.

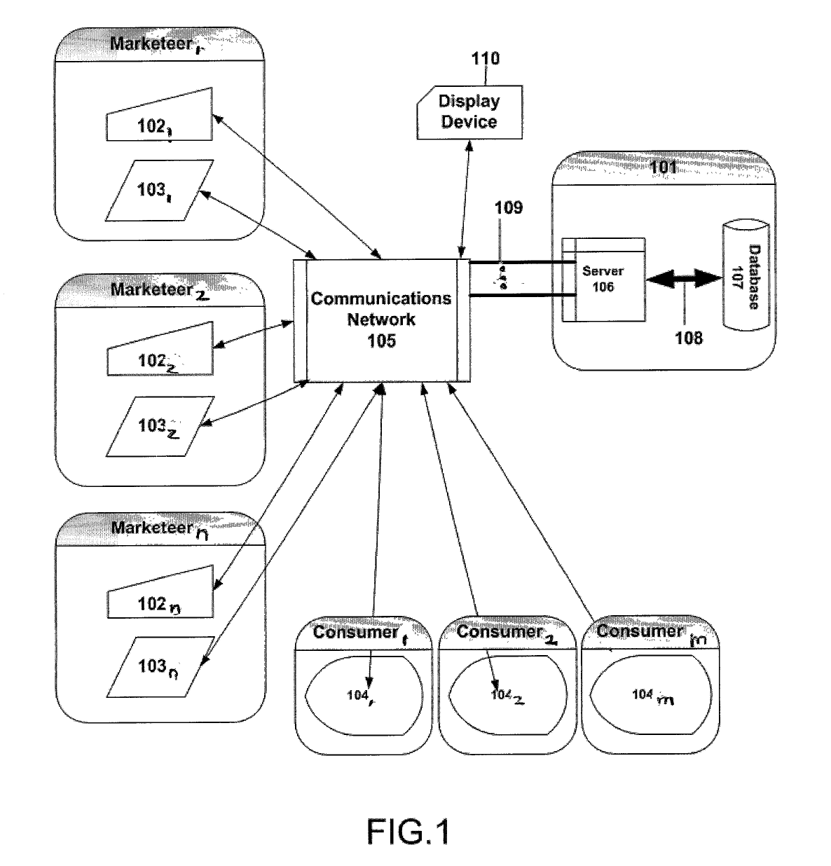

Each participating consumer, upon electing to participate in the group, has an account established in accordance with the proposed marketing arrangement. This account accrues value for the associated participating consumer in several ways. Value is accrued in an account upon the purchase of goods and/or services. The mere purchase of a product or service by a participating consumer can be enough for value to accrue in that consumer's account. Or, in addition, additional value, i.e. value other than that provided by the purchase of a product alone, can accrue in the participating consumer's when a particular identification on the product, is scanned at or after the time of purchase. What is contemplated here is that manufacturers can put an identification or code on their product. This identification would advantageously eliminate the need for paper coupons and rebates. At the time of purchase or thereafter, the code is scanned and value is accrued in addition to that accrued for the purchase of the product. To avoid fraud, the identification can be put on the label affixed to the item using a number of well-known techniques that inhibit label removal. Or, the label can be scanned at the time of purchase and validated against an actual purchase of the item before any value is accrued in the participating consumer's account. Another way of accruing value is by a participating consumer electing to undertake certain activities. One activity, for example, is that the participating consumer swipes his/her identification card or tag in an electronic reader upon entering a particular store. Another activity, for example, is that a participating consumer surfs the Internet and, while doing so, clicks on banners with a computer pointing device or accesses certain web sites. Still another exemplary activity is a consumer's signing up to participate in the proposed marketing arrangement. Yet another exemplary activity is the act of watching television. For example, television commercials can advertise some predetermined information or code that is associated with the group. All participating consumers, upon viewing the commercial, can then accrue value in their accounts by accessing a database, e.g. database 107 in FIG. 1, providing a personal identification and the code. This technique is not limited to television commercials. Television networks can utilize this concept of value accrual by displaying predetermined information along with the display of their network logos or while communicating an upcoming program or event. Similarly, radio stations and/or networks can recite some predetermined information. Participating consumers who listen to the radio station and/or network can accrue then value in their accounts using the procedure described for television commercials. The ways of accruing value in a consumer's account are virtually boundless.

The value accrued though any purchase of goods and/or services is a function of both the cash value of the purchased goods and/or services and a “pay out” factor. The pay out factor is selected by each marketer of goods and/or services and can be varied by that marketer in real-time. The pay out factor for any marketer can be fixed for all its goods and/or services. Or, the pay out factor for any marketer can be different for different goods and/or services. Indeed, a marketer has the ability to individually set the pay out factor for each of its goods and/or services. In this manner and coupled with the real-time adjustment of the pay out factor, a marketer can take into account its current inventory of a particular product and, when the inventory is higher than desired, stimulate sales of the particular product by increasing the pay out factor for that product. Similarly, when there is an unanticipated demand for a product that is in short supply and not readily replaceable, a marketer can reduce the pay out factor for such product. The same methodology can be followed with respect to services. For example, the demand for a service, the ability of a marketer to provide the service, and the number of competing marketers are three different variables that may be considered by a marketer when selecting the pay out factor for a service. As with goods, the selection by a marketer of the pay out factor for a service can be made in real-time. A marketer can also adjust its pay out factor to account for actions taken by one or more of its competitors for a particular type of goods and/or services. In short, a pay out factor can be varied so as to track, lead, or lag the competition.

In one contemplated scenario, the pay out factor is multiplied by the cash value of the goods and/or services purchased to establish the accrued value for that purchase. The higher the pay out factor, the greater the accrued value upon a purchase. The pay out factors for all participating marketers are stored in a database. This database is accessible to all participating consumers in real-time via conventional communications networks. Each participating consumer has access to this database and the current pay out factors can be obtained therefrom. The pay out factors can also be communicated to participating consumers without such consumers accessing the database.

In another contemplated scenario, the accrued value is determined by dividing the cash value of the goods and/or services purchased by the pay out factor. This would be the case where the pay out factors are equal to or less than one. To stimulate sales, a marketer would then reduce its pay out factor to a number less than 1. This scenario is perceived to be confusing to many consumers and, therefore, less desirable than the first contemplated scenario where pay out factors greater than 1 are used to promote sales.

Communication of the pay out factors to participating consumers is done in several ways. In one way, information in the database is accessible to members of the group through a dial-up connection. In another way, information in the database is communicated to participating consumers through publicly accessible electronic messaging boards, and/or personal communication devices owned by a participating subscriber. These latter devices include, but are not limited to, desktop or laptop personal computers and/or hand-held portable personal directory assistants, e.g. a “palm devices”. The above-discussed methods used to communicate the pay out factors to participating consumers are not exclusive and may be used in combination.

The value accrued in any participating consumer's account can be redeemed for goods and/or services. The value accrued can also be redeemed for cash, albeit at a small exchange rate. The types of redeemable goods and/or services are unlimited. The value needed for redemption is a function of both the cash value of the goods and/or services to be redeemed and a “buy back” factor. This buyback factor, like the pay out factor, is determined by each marketer for its goods and/or services and is communicated to a database that is accessible to group members. The marketer can change the buy back factor, like the pay out factor. Each marketer has the ability to vary the buy back factor for its goods and/or services. The buy back factor for any marketer may be the same for all its goods and/or services. Or, each marketer can set different buy back factors for each of its goods and/or services. As is the case for any pay out factor, each marketer may make in changes in the buy back factor real-time. However, to avoid potential disruptions or confusions, it is preferable that variations in buy back factors be reflected in the database on set intervals. A daily updating of the buy back factor is considered preferable. The current buy back factors for all participating marketers are communicated to a database and stored therein. Again, this database is accessible to participating consumers. The manner of accessing the database to obtain current buyback factors is identical to that described for the pay out factor.

In view of the above, the present marketing arrangement for goods and/or services with its pay out and buy back factors is analogous to foreign currency exchange businesses which display buy and sell rates when exchanging one currency for another. With this thought, the value accrued and redeemed can be viewed as currency—not legal tender issued by a sovereign power—but one that is acceptable within a virtually boundless group of consumers and marketers. And, since the pay out factors and buy back factors for each marketer may be varied by that marketer electronically, each marketer can stimulate sales of its goods and/or services by raising its pay out factor and can maintain customer loyalty by adjusting its buy back factor. Furthermore, since these factors are rapidly communicated to participating consumers, each consumer can make judicious selections when purchasing goods and/or services and has the same capability when redeeming accrued value. In short, each consumer can get the “biggest bang” when either spending his/her money or redeeming his/her accrued value.

Refer now to FIG. 1 which shows an illustrative block-schematic diagram of a system 100 which implements the proposed marketing arrangement for a group of marketers and consumers. The participating marketers are designated in FIG. 1, as marketer₁, marketer₂, . . . marketerₙ, where n is some large number. Similarly, the participating consumers are designated as consumer₁, consumer₂, . . . consumerₘ, where m is a large integer which may be equal to or different from n. Each marketer has an associated administration terminal, such as a personal computer, and one or more devices at each of that marketer's selling locations for communicating with location 101. The administration terminals for marketer₁, marketer₂, . . . marketerₙ are respectively designated as 102₁, 102₂, . . . 102ₙ. These administration terminals are used by each marketer to communicate that marketer's pay out and buy back factor through communications network 105 to location 101 where they are stored. The collection of devices at each of the selling/redemption locations of marketer₁, marketer₂. . . marketerₙ are respectively designated as 103₁, 103₂, . . . 103ₙ. Each of these devices is used in the process of accruing value to the accounts of any of the consumers shown in FIG. 1 and, in addition, is used in the process of redeeming accrued value for goods and/or services. Devices 103₁, 103₂, . . . 103ₙ may be respectively disposed at the same location as administration terminal 102₁, 102₂, . . . 102ₙ. Such could be the case where a marketer has only a single location for the sale of goods and/or services. For a marketer having multiple locations for the sale of goods and/or services, devices 103 for that marketer would be located at each such location. For simplicity of administration, such a marketer would generally have a single administration terminal so that the pay out and buy back factors for that marketer are revised in real-time in a coordinated and orderly manner.

In FIG. 1, consumer₁, consumer₂, . . . consumerₘ has an associated terminal 104₁, 104₂, . . . 104ₘ for communicating with location 101. Such terminals, associated with a consumer, may be a personal computer or the like which is located at the consumer's home or place of business. Any consumer need not have an associated terminal for communication to location 101 as the pay out factors and buy back factors are advantageously communicated to participating consumers through other means, as will be discussed. However, such capability is advantageous as it permits a consumer to access the location 101 and view his/her account information and/or view the pay out and buy back factors for participating marketers. System 100 also advantageously utilizes one or more devices 109 for displaying the same information viewable on a consumer's associated terminal. Display device 110 may be an electronic messaging board located in a publicly-viewable kiosk, may be a display device proximate to any or all of devices 103₁ through 103ₙ, or may be a portable, hand-held personal communications device of a participating consumer.

Communications network 105 which interconnects participating consumers, participating marketers, and the display devices to location 101 may be any conventional public or private communications network capable of handling data communications. This network may be wired, wireless or a communication of both. In FIG. 1, network 105 is a public switched telephone network providing concentration so that the number of connections 109 to the network from location 101 is less than the total number of connections from all participating marketers and all participating consumers.

Server 106, disposed at location 101 is a file server which interfaces with communications network 105. Server 106, of conventional design, communicates with database 107 through bus 108. Database 107 stores information for each participating consumer and each participating marketer.

The latter type of information includes an identification of each marketer along with its current pay out and buy back factors. Prior pay out and buy back factors may also be stored for a predetermined past interval. The pay out and buy back factors may be the same for all products and/or services of a particular marketer or may be different. In either case, each marketer has the ability to change its pay out or buy back factor. As will be discussed, the current pay out and buy back factors for a participating marketer can also be displayed on devices 109. Database 107 also stores account information for each participating consumer. This information includes the usual information which identifies the participating consumer, e.g., name, address, telephone number, the value accumulated in that participating consumer's account, and other information. Such other information may include demographics about the participating consumer. The value in the account of a participating consumer is incremented for any of the variety of reasons. These include the purchase of goods and/or services and the consumer's participation in certain activities as described above. Similarly, the value stored for any consumer is decreased upon the redemption of accumulated value for goods and/or services or conversion into cash.

Devices 103₁,103₂ . . . 103ₙ transmit information to location 101 upon the purchase of goods and/or services. Each of these devices incorporates the appropriate communications interface for connection to network 105. That is, where the communications link in network 105 directly connected to the device is a “wired” connection, such a metallic cable (twisted pair, coax, etc.) or optical fiber, the device incorporates an appropriate transceiver for interconnection to the particular media. If, on the other hand, the communications link directly connected to a device 103 is wireless, than the device 103 incorporates an appropriate wireless transceiver. In the proposed marketing arrangement wherein each marketer can change the pay out factor in real-time, the information transmitted from the point of sale to location 101 may be the cash value of goods and/or services purchased. In such case, at location 101, the cash value of the purchased goods and/or services is multiplied by the current pay out factor for these goods and/or services. Alternatively, this multiplication can be done at the point of sale and the product of the cash value of the goods and/or services and the current pay out factor for the purchased goods and/or services is transmitted to location 101. In either case, the value in each participating consumer's account is maintained at location 101. This value reflects the purchases of and the activities undertaken by of each participating consumer. The value accrued for each purchase of goods and/or services from a participating marketer is a function of the cash value of those goods and/or services and the associated pay out factor at the time of sale. Similarly, in the situation wherein a participating consumer accrues value for undertaking certain activities, the value accrued is a function of an established base value for that activity multiplied by the pay out factor at the time the activity is performed. Again, a marketer or a collection of marketers sponsoring an activity may control the pay out factor for that activity in real-time.

Redemption of value from a participating consumer operates in much the same way as the accrual of value. The consumer can access the current buy back factors from location 101. This access can be provided via the consumer's associated device 104 or may be viewed at device 109. In either case, the consumer makes a selection of goods and/or services and, instead of paying cash, can use accrued value to buy the selected item. In one scenario used in system 100, the quantum of value taken from that consumer's account is equal to the cash purchase value of the selected item divided by the current buy back factor for that item. This is the case for buy back factors which are equal to or greater than 1. Alternatively, in a second scenario, the buy back factor may be equal to or less than 1. If this is the case, than the value redeemed for the goods and/or services is the cash value of such goods and/or services multiplied by the buy back factor. The second scenario for buy back factors is considered less desirable than the first scenario as it is analogous to less is better than more and, therefore, is believed more confusing to consumers.

The buy back factor is variable and under the control of the marketer for that item. In the preferable arrangement, the higher the buy back factor, the lower the value decreased from a consumer's account for any given redemption. In another arrangement, goods and/or services can be purchased using a combination of actual cash or legal tender and accrued value in a consumer's account. That is, the consumer not having sufficient accrued value in his/her account to make a purchase can offset part of the cash purchase price using accrued value. The offsetting amount in a purchase by a participating consumer is equal to the quantum of value redeemed from that consumer's account multiplied by the buy back factor. So, for example, if a participating consumer desires to buy goods totaling $75.00 cash and the applicable buy back factor is 1.5, the quantum of value redeemed from the participating consumer's account is 50. If, in this same transaction, the participating consumer only has a value of 30 in his/her account, than the consumer could redeem all this value and, in addition, use $30 in cash for the purchase.

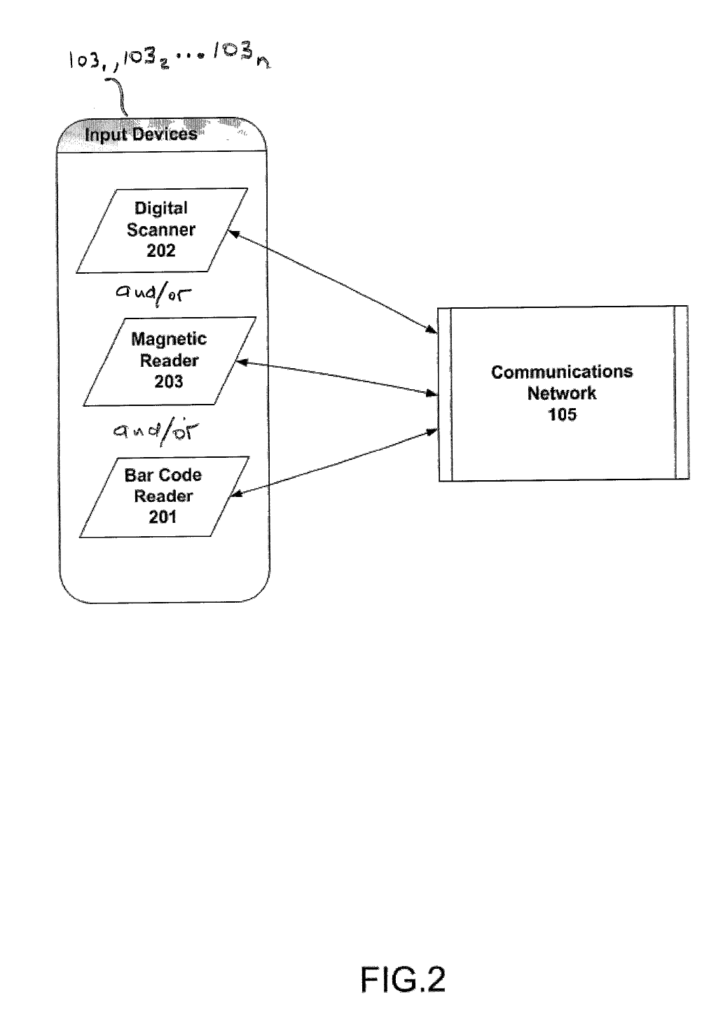

While a single device 103 is shown in FIG. 1 for a particular marketer, a number of different devices 103 can be used at any selling/redemption location. As shown in FIG. 2, device 103 for any marketer may be any of a number of well-known devices. These devices include, but are not limited to, a bar code scanner 201, a digital scanner 202 and/or a magnetic stripe reader 203. The utilization of a variety of different data inputting devices permits flexibility in the accrual and redemption of value in a consumer's account. Each of the devices shown in FIG. 2 incorporates the appropriate interface device for connection to communications network 105. Wireless transceivers, not shown, may be incorporated into any such device, as appropriate, to permit interface to a wireless link in communications network 105.

When display device 110 of FIG. 1 is a kiosk, such kiosk can be implemented in several forms. In its fundamental form, a kiosk can be located in a retail store of a participating marketer and can display the current buy back and pay out factors for that participating marketer. The kiosk may also permit a participating consumer to view his/her accrued value upon entry of certain identifying information known only to system 100 and that participating consumer. Any of a number of security systems, such as the use of private codes or personal identifying numbers (“PINS”) may be used to insure that a participating consumer only accesses his/her account information. In another form, the kiosk can display the information just described and, in addition, can display the pay out and buy back factor of participating marketers other than the participating marketer owning the retail store in which the kiosk is located. In this manner, a participating marketer can stimulate sales by displaying its better pay out factors compared to its competition. Customer loyalty may also be stimulated by display of a marketer's buy back factors along with those of its competitors. In yet another form, the kiosk can be in a public place in a shopping mall and could display the current pay out and buy back factors for all or a portion of the participating marketers selling goods and/or services in the mall.

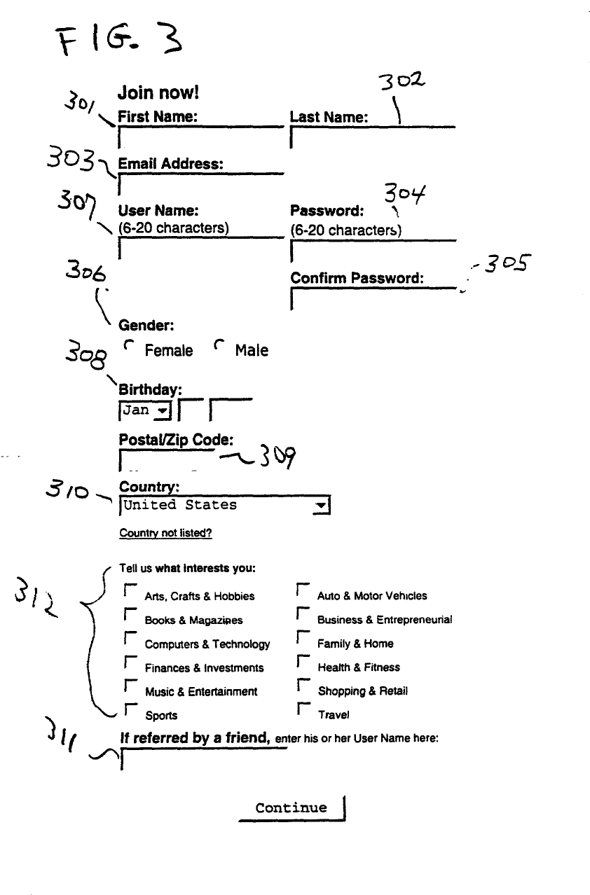

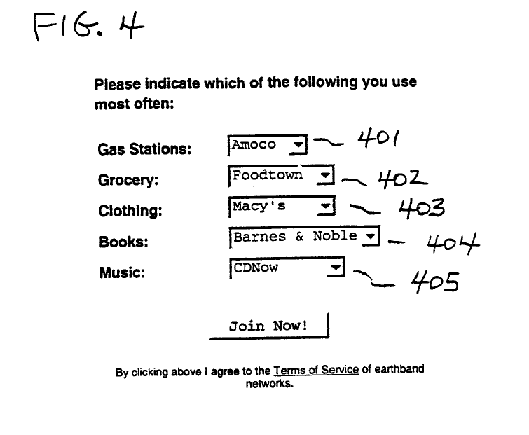

FIG. 3 shows the video screen viewed by a consumer upon accessing a sign-up web page that provides the ability for that consumer to join the group. As shown, the sign-up process can be rapidly completed. Locations 301-306 are respectively provided for the entry of names, e-mail address, password, and gender. A user name is also requested and inserted into location 307 and is the desired identification system 100 uses when communicating with a participating consumer. The birthday of a participating consumer may be solicited at location 308 to be later used for the sending of a timely birthday greeting. Postal zone and country information at locations 309 and 310 provide additional valuable information about where participating consumers reside and may be compiled with that of other participating consumers and furnished to marketers along with data about the buying habits of a participating consumer pr a group of participating consumers. Location 311 solicits the name of any participating consumer who prompted a consumer to join the group. The use of location 311 provides yet another mechanism, for participating consumers to accrual value in their account. The notion here is that some predetermined value can be accrued in the account of a participating consumer who encourages a new consumer to join the group and that consumer then actually joins the group. Locations 312 may be used, if desired, to solicit the interests of a consumer signing up to join the group. This information begins the process of accumulating information about the interests of each participating consumer. It is recognized here that such information is of value to marketers. In addition, the gathering of such information can be used, in whole or in part, in the construction of a personalized page viewable by each participating consumer upon accessing remote location 101 from his/her computer or from display device 110. The information requested at locations 312 can be complemented by the solicitation of additional information as shown in FIG. 4. As shown in FIG., 4 a number of predetermined categories—gas stations, grocery, clothing, books and music are shown. The categories displayed in FIG. 4 can be based on the selections checked at locations 312 in FIG. 3. “Pull-down” menus 410-405 are provided for the displayed categories. Each menu allows a consumer to indicate his favorite marketer for each of the displayed categories.

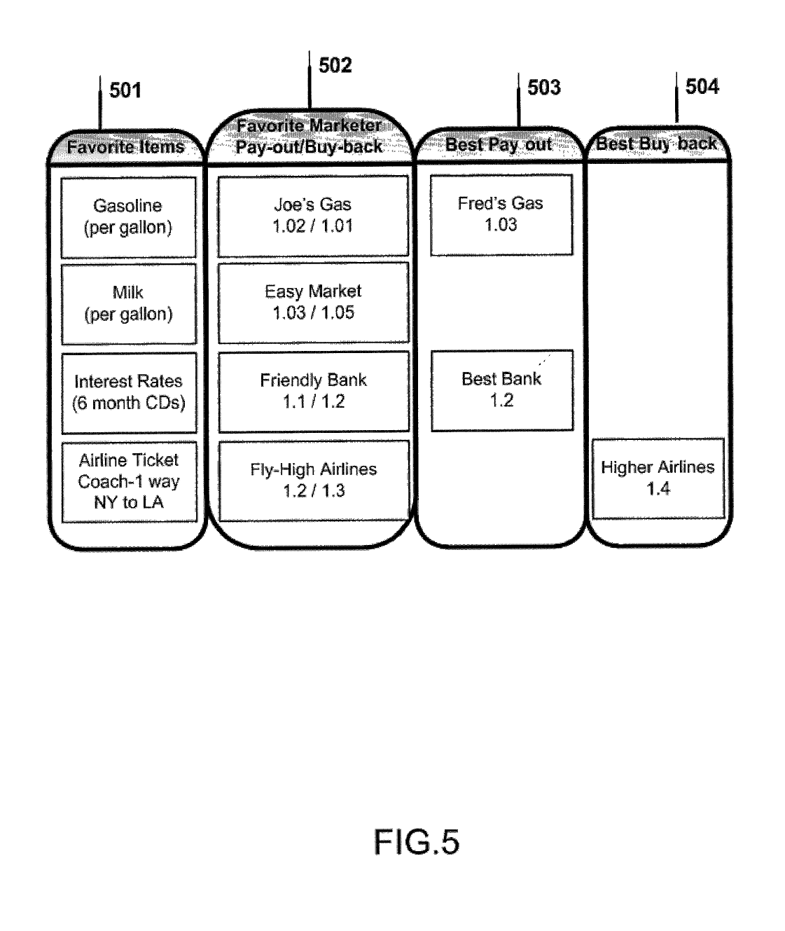

Refer now to FIG. 5, which shows a personalized page viewable by a participating consumer. Upon accessing location 101 and establishing a connection to database 107 in well-known fashion, a participating consumer can view the accrued value in his/her account. In addition, for this consumer, “favorite” items, along with “favorite” marketers for the favorite items, and “best” pay out factors and buy back factors for the favorite items can be displayed. Such a display can be constructed by the gathering of information of the type described in reference to FIGS. 3 and 4, by an analysis of the purchases of goods and services accrued and redeemed by a participating consumer, or by any combination of the foregoing. In any event, system 100 can provide a video screen of the type shown in FIG. 5. As shown, screen 500 displays a list of favorite items 501 for which the consumer desires to gather information. This list includes gasoline, milk, interest rates on 6-month certificates of deposit (CDs), and airline tickets, coach class, one-way, between city “A” to city “B”. Column 502 displays the favorite marketer for each favorite item. The favorite marketer is identified for each item along with that marketer's current pay out and buy back factor. Identification of any marketer on screen 500 may either be by the marketer's name, the marketer's logo, or a combination of both. Columns 503 and 504 respectively identify the participating marketer, if any, offering a better pay out and a better buy back factor than the favorite marketer. As one marketer may provide the best pay out factor and another may provide the best buy back factors, two separate columns 503 and 504 are provided in screen 500. As shown in FIG. 5, screen 500 indicates that there are no marketers offering better pay out or buy back factors for milk that those listed for Easy's Market in column 502. However, screen 500 reveals that for the purchase of a gallon of gasoline, Fred's Gas is providing a higher pay out factor than that offered by Joe's Gas, that Best Bank is providing a better pay out factor than that offered by Friendly's Bank on a six month Certificate of Deposit, and Higher Airlines is providing a better buy back factor than that offered by Fly-High Airlines for the specified airline ticket.

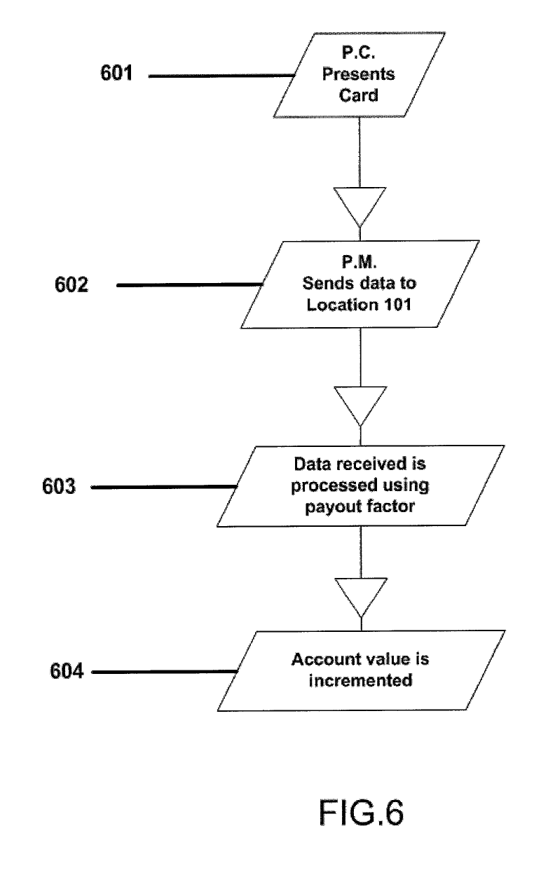

Refer now to FIG. 6 that shows the process 600 implemented upon the purchase of goods and/or services by a marketing arrangement in accordance with the present invention. Process 600 may either be implemented in real-time, i.e., immediately upon the purchase of goods and/or services or may be performed on a predetermined basis, i.e., after the close of each business day or week, or month, etc. At step 601, the participating consumer, hereinafter referred to as “PC”, presents his identification card to the participating marketer, hereinafter referred to as “PM”, at the point of sale. The cash value of the goods and/or services purchased is transmitted at step 602 to location 101 of FIG. 1. Other data is also transmitted. Such other data includes an identification of the goods and services purchased, the time, date, the PM, its retail location, and the PC. At step 603, server 106 of FIG. 1, examines the received data, extracts the identification of the PM and retrieves the current pay out factor for this PM. This factor is then multiplied by the cash value of the goods and/or services purchased. The PC identification in the received data is then examined and, at step 604, the account of this PC is then increased by an amount equal to the product formed in step 603. The transmittal of an identification of the PC, PM, goods and/or services purchased provides valuable information about the spending habits of the PC. This information may be sold to PM and non-PMs. In addition, it can be used as another mechanism for constructing a personalized page for any PC which displays frequently purchased goods and/or services. This other data, as will be discussed, may also be transmitted for any redemption.

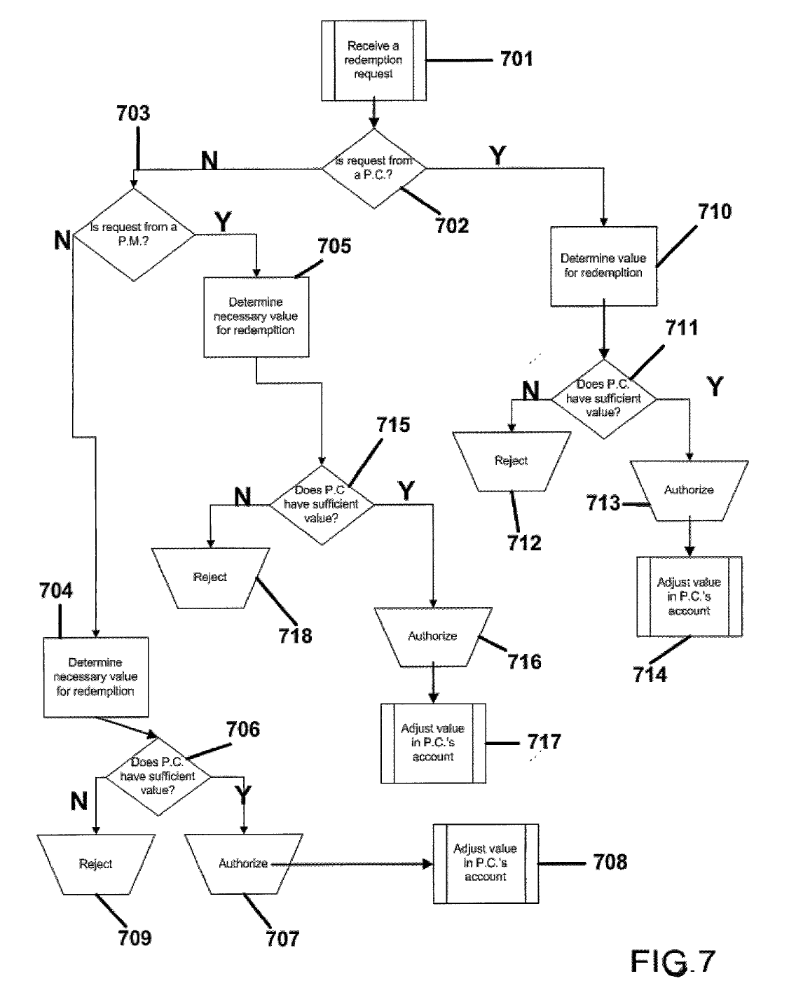

FIG. 7 is a flow-chart of the operations associated with the redemption of value from a participating consumer's account. At step 701, a redemption request is received. This request may come directly from the point of redemption, e.g., the retail location where the participating consumer is using his accrued value to purchase goods and/or services. Or, alternatively, in situations where the proposed marketing arrangement is integrated or associated with an existing credit card or debit card, the request received at step 701 would originate from the retail location which would send it to the entity responsible for processing the associated credit or debit card transactions. This entity, in turn, would forward the request to server 106 at location 101 of the exemplary system 100 shown in FIG. 1. The redemption of all or a portion of the value accrued in the account of a participating consumer for actual legal tender, i.e., cash, is also contemplated. Any cash redemption would originate from a location having automated teller machine (“ATM”) machine capabilities. In either event, the received data at step 701 includes an identification of where the request originated, an identification of the participating consumer, an identification of the marketer, if any, and the cash selling price of the goods and/or services to be redeemed, or the amount of actual legal tender requested. In the case of redemption for cash, no marketer is identified.

At step 701, the received data is examined to determine if the request is from a participating consumer, designated in FIG. 7 as “P.C.”, or from a marketer. In FIG. 7, a participating consumer is designated as “P.C.”. This determination is made by examining the source of the redemption request. If it originates from a location having ATM capabilities, then the request is deemed to be a redemption of accrued value for cash. In this event, processing continues on to step 711 where a determination is made as to whether there is sufficient accrued value in the participating consumer's account to cover the cash requested. This is done by comparing the amount of cash requested to the quotient obtained by dividing the accrued value in the participating consumer's account by a default buyback factor for any cash redemption. This factor can be changed as necessary. Assume that this factor is 5. If so, then at step 711, the accrued value in the account of the participating consumer identified in step 701 is divided by 0.5, the quotient obtained is then compared to the cash requested. If the quotient is equal to or greater than the cash requested, the cash redemption is authorized at step 713 and a signals are transmitted to the ATM machine causing the requested cash to be dispensed. At step 714, the quotient obtained in step 710 is subtracted from the accrued value in the account of the consumer identified in the step 701. If, however, the accrued value in the account of the participating consumer identified in the request received at step 701 is less than the quotient obtained at step 711, the request for a cash redemption is rejected at step 712 and no cash is dispensed to the participating consumer identified in step 701.

If step 702 determines that the request has not originated from a location having ATM machine capabilities, then processing proceeds to step 703. At step 703, a determination is made as to whether the redemption request received at step 701 is for a participating marketer or from a marketer who does not participate in the proposed marketing arrangement. Participating marketers in FIG. 7 are designated as “P.M.” All participating marketers have a code which is maintained in database 107 shown in FIG. 1. If, at step 703, an examination of the code for the marketer in the redemption request is not one of a participating marketer, processing proceeds to step 704 where a determination is made as to whether there is sufficient accrued value in the account of consumer requesting the redemption to permit the redemption. As with cash redemption, there is a default buyback factor for any marketer who is not a participating marketer. Assume this value is 0.7. If so, then at step 704, the cash value of the goods and/or services to be redeemed for value is divided by 0.7 and the quotient obtained is used at step 706. At step 706, a comparison is made of the quotient just described to the accrued value in the account of the participating consumer identified in step 701. If the quotient is equal to or greater than the accrued value in the requesting consumer's account, the redemption for goods and/or services is authorized at step 707 and a signal to the effect is provided to the point of redemption identified in the received request. At step 708, the quotient obtained in step 704 is subtracted from the accrued value in the account of the consumer identified in the step 701. If, however, the accrued value in the account of the participating consumer identified in the request received at step 701 is less than the quotient obtained at step 704, the redemption request is rejected at step 709.

The processing for a marketer identified in a redemption request as a participating marketer is provided by steps 705, and steps 715-718. If the code in the redemption request matches a code for a participating marketer at step 703, processing proceeds to step 705. The current buy back factor for the identified participating marketer is obtained from database 107 in FIG. 1 and the cash value of the goods and/or services to be redeemed is divided by this buy back factor at step 705. The quotient obtained is then used at step 715 and compared to the accrued value to the accrued value in the account of the participating consumer identified in step 701. If the quotient is equal to or greater than the accrued value in the requesting consumer's account, the redemption for goods and/or services is authorized at step 716 by a signal to the point of redemption identified in the received request. At step 717, the accrued value in the account of the consumer identified in the step 701 is decreased by the quotient obtained in step 705. If, however, the accrued value in the account of the participating consumer identified in the request received at step 701 is less than the quotient obtained at step 705, the redemption request is rejected at step 718 and a signal to this effect is provided to the point of redemption.

In accordance with another aspect of the present invention, information of the type valuable to marketers can be gathered. After being gathered, the information can be distributed upon the request of a marketer or can be distributed to those marketers which subscribe to and pay for such distribution. The marketers receiving the information may be participating marketers as well as non-participating marketers. The gathered information can include a number of things that are of value to a marketer. There is a great deal of flexibility here. For example, personal information about a participating consumer—age, income, address, etc. which may be solicited by the system upon each consumer's signing up to be a participating consumer. In addition, data can be gathered at the time of each purchase of goods and/or services by each participating consumer. What is envisioned here is akin to the use of serial numbers on legal tender or currency for tracking or identification of the currency. In the proposed scheme, upon any accrual of value in a participating consumer's account for the purchase of goods and/or services, the date, the time, the type of goods purchased, an identification of the manufacturer, the retailer, etc., can be stored along with the accrued value for the purchase. This can be accomplished by adding additional fields of data into the data record maintained in each participating consumer's account upon each accrual of value in that account. As accrual of value can also occur when a participating consumer elects to participate in certain activities, information about such activities, e.g., the date, time frequency, type of activity, etc. can similarly be stored. Once such information or data is stored, it can be searched and reports furnished to retailers, distributors and/or manufacturers or others which identify those participating consumers of a particular marketer. Identification of the types of goods and/or services purchased, the frequency of such purchases, etc. can also be provided. In the case of activities, which accrue value and are other than the purchase of goods and/or services, the date, time, type of activity, etc. can be identified at the time of accrual, stored and later provided to those interested in such information. In any event, with the furnishing of information of the type described, advertisements, either electronically or by other means, can be specifically provided to particular participating consumers.

This notion of “serialization” can be expanded to the redemption of value from a participating consumer's account. That is, upon each redemption of value, the participating consumer making the redemption, the date, time, goods and/or services redeemed, the retail store where redeemed, etc. can be stored in a redemption record. With this additional redemption record, the information gathered and furnished to marketers would not only identify participating consumers who purchase goods and/or services from any marketer but would also provide an indication of customer loyalty. That is, information about whether a participating consumer uses his/her accrued value to redeem goods and/or services of the kind previously purchased from or manufactured by a particular marketer can be tracked and furnished to marketers. If accrued value is used for purposes other than the purchase of the kind that accrued the value redeemed, this information can be tracked and furnished as well. A first-in, first out system would work here. That is, when redemption is made for some quantum of value from the account of a participating consumer, the value redeemed would be taken against the accrued value in a participating account that is oldest. The notion of age or oldest is determined from the difference between the date any value was accrued and the date of a redemption. The oldest accrued value on any date of redemption is that value accrued on the earliest date. For any redemption, the amount needed for any redemption may be less than the value accrued on a particular date. If so, there would be value remaining for a particular date after a redemption of part of the value accrued for that particular date. This remaining value can be used for a subsequent redemption.

The fact that participating consumers are identified by means of their card, key tag or the like has other possibilities as well. Upon being identified, e.g. at the time of making a purchase, making a redemption, entering a store and swiping the identification card or key tag, information of the kind designed to promote sales, loyalty, good will can be communicated by means of any of a number of conventional display devices. These display devices, one of which is designated in FIG. 1 by reference numeral 110, are connected to the system of FIG. 1 by wired or wireless communications paths. The content of the communication can take many forms. For example, a personal greeting which identifies the participating consumer by name, or acknowledges a personal event, such as a birthday, anniversary, etc. may be provided. Or, for example, advertisements or notification of special discounts with respect to goods and/or services of the kind frequently purchased by the identified participating consumer may be provided. In any event, the display device is visible to the identified participating consumer at the time of identification. The display device, for example, can be at the entrance of a store or at the point of sale devices. The advertisement or communication can be of the type designed to promote the purchase of goods and/or services at the time communicated or at some subsequent time.

It should of course be understood that while the present invention has been disclosed in reference to a particular embodiment, numerous other arrangements may be envisioned by those skilled in the art without departing from the spirit and scope of the present invention. Furthermore, for purposes of the claims set forth hereinbelow, the phrase “goods and services” shall mean goods and/or services.

I claim:

1. A method of doing business in an environment having consumers and marketers of goods and services, said method comprising the steps of
providing an account for a consumer in a database which identifies said consumer and maintains a value parameter for said consumer, said value parameter being redeemable toward acquisitions of items; and
increasing said value parameter associated with said consumer upon a predetermined event, said predetermined event having an associated value and an associated marketer, said increase being provided to said database wherein it is added to said value parameter for said consumer, said increase being a function of the value of said event and a factor associated with said event and alterable by in real-time by the marketer associated with that event.

2. The method of claim 1 wherein each of said goods and services has an associated selling price and said predetermined event is a purchase of a particular one of said goods and services for its selling price and said increase is a function of that selling price and said factor.

3. The method of claim 1 wherein said predetermined event is a particular response by said consumer to a communication received by said consumer.

4. The method of claim 1 further including the step of decreasing said value parameter by an amount, said decrease being associated with a redemption of a predetermined portion of the stored value parameter for one of said items, said one item having an associated value and said amount being a function of this value and a second factor alterable in real-time.

5. The method of claim 4 wherein said second factor is a default factor alterable by one or more predefined persons and said item is cash.

6. The method of claim 4 wherein said second factor is alterable by a marketer associated with said one item and said item is selected by said consumer from a number of said goods and services.

7. The method of claim 2 wherein said method also includes the step of providing information about the particular one of said goods and services purchased from one of said marketers and said account also maintains this information.

8. The method of claim 7 wherein said information about the particular one of said goods and services purchased includes an identification of such goods and, services.

9. The method of claim 7 wherein said information about the particular one of said goods and services purchased includes an identification of said one marketer.

10. The method of claim 7 wherein said particular one of said goods and services is goods manufactured by a manufacturer and the information provided includes and identification of this manufacturer.

11. The method of claim 7 wherein said particular one of said goods and services is a service provided by a service provider and the information provided includes and identification of this service provider.

12. The method of claim 7 wherein said information provided indicates the frequency that the particular one of said goods and services is purchased.

13. The method of claim 7 wherein said information provided indicates the time and date that the particular one of said goods and services is purchased.

14. A method of doing business in an environment having consumers and items each having an associated value, said method comprising the steps of
establishing an account for a consumer in a database which identifies said consumer and has a value parameter for said consumer, said value parameter being redeemable toward said items; and
decreasing said value parameter by an amount, said decrease being associated with a redemption of a predetermined portion of the stored value parameter for an item desired by said consumer, said item having an associated value and said amount being a function of the value of the item redeemed and a factor alterable in real-time.

15. The method of claim 14 wherein said factor is a default factor alterable by one or more predefined persons and said item is cash.

16. The method of claim 14 wherein said factor is alterable by a marketer associated with the item and said item is selected by said consumer from a number of goods and services.

17. The method of claim 14 wherein said method also includes the step of providing information about said item and said account also maintains this information.

18. The method of claim 17 wherein said item is a particular one of a number of goods and services and said information provided includes an identification of the same.

19. The method of claim 17 wherein said item is redeemed from a marketer and said information provided includes an identification of said marketer.

20. The method of claim 17 wherein said item is a particular one of a number of goods, said item having an associated manufacturer and the information provided identifies the manufacturer associated with the redeemed item.

21. The method of claim 17 wherein said item is a particular one of a number of services, each of such services being provided by an associated service provider, and the information provided includes and identification of the provider associated with said item.

22. The method of claim 17 wherein said information provided indicates the frequency that value is redeemed from the account.

23. The method of claim 17 wherein said information provided indicates the time and date that said item is redeemed.

24. A system for doing business in an environment having consumers and marketers of goods and services, said system comprising
means for providing an account for a consumer in a database which identifies said consumer and maintains a value parameter for said consumer, said value parameter being redeemable toward items; and
means for increasing said value parameter associated with said consumer upon a predetermined event having an associated value and an associated marketer, said increase being provided to said database wherein it is added to said value parameter for said consumer, said increase being a function of said event and a factor associated with said event and alterable in real-time by the marketer associated with that event.

25. The system of claim 24 wherein each of said goods and services has an associated selling price and said predetermined event is a purchase of a particular one of said goods and services for its selling price and said increase is a function of that selling price and said factor.

26. The system of claim 24 wherein said predetermined event is a particular response by said consumer to a communication received by said consumer.

27. The system of claim 25 wherein said increasing means includes a point of sale terminal for tallying a purchase of goods and services by a consumer.

28. The system of claim 27 wherein said point of sale terminal transfers an amount to said account.

29. The system of claim 28 wherein said amount is a function of the selling price of the purchased goods and services and its associated factor.

30. The system of claim 28 wherein said increasing means includes means for altering said amount with alterations in said factor.

31. The system of claim 24 further including a means for displaying the maintained value parameter.

32. The system of claim 24 further including a means for displaying the factor for any of a number of goods and services at any time.

33. The system of claim 32 wherein said displaying means is located in a kiosk and is viewable by the public.

34. The system of claim 32 wherein said displaying means is located at a point of sale terminal.

35. A system for doing business in an environment having consumers and items, each item having an associated value, said system comprising
means for providing an account for a consumer in a database which identifies said consumer and has a value parameter for said consumer, said value parameter being redeemable toward items; and
means for decreasing said value parameter by an amount, said decrease being associated with a redemption of a predetermined portion of the stored value parameter for an item desired by said consumer, said item having an associated value and said amount being a function of the value of the item redeemed and a factor alterable in real-time.

36. The system of claim 35 wherein factor is a default factor alterable by one or more predefined persons and said item is cash.

37. The system of claim 35 wherein said factor is alterable by marketers of goods and services and said item is selected by said consumer from a number of goods and services.
